(19) United States
(12) Patent Application Publication
(10) Pub. No.: US 2025/0312959 A1
(43) Pub. Date: Oct. 9, 2025

(54) DIE ASSEMBLY AND PROCESS FOR PELLETISING ULTRA-HIGH MOLECULAR WEIGHT POLYETHYLENES

(71) Applicants: SABIC GLOBAL TECHNOLOGIES B.V., Bergen op Zoom (NL); WISCONSIN ALUMNI RESEARCH FOUNDATION ("WARF'), Madison, WI (US)

(72) Inventors: Priya GARG, Vaals (NL); Thomas Daniel LANGSTRAAT, Leuven (BE); Martin Antonius VAN ES, Epen (NL); Kar-Man Raymond CHU, Maastricht (NL); Lih-Sheng TURNG, Madison, WI (US); Huaguang YANG, Guangzhou (CN); Galip YILMAZ, Izmir (TR)

(21) Appl. No.: 18/855,119

(22) PCT Filed: Apr. 3, 2023
(86) PCT No.: PCT/EP2023/058724

§ 371 Date: Oct. 8, 2024

(30) Foreign Application Priority Data
Apr. 8, 2022 (EP) 22167458.3

(51) Int. Cl. B29C 48/00; B29C 48/30; B29C 48/87; B29C 48/92; B29K 23/00

(52) U.S. Cl. CPC B29C 48/0022; B29C 48/022; B29C 48/30; B29C 48/87; B29C 48/92; B29C 2948/92514; B29C 2948/926; B29C 2948/92704; B29C 2948/92876; B29C 2948/92904; B29K 2023/0683; B29K 2995/0088

(57) ABSTRACT

The present invention relates to a novel die assembly for the melt extrusion of ultra-high molecular weight polyethylene (UHMWPE) comprising a tapered channel section, and a process for pelletising UHWMPE using such die assembly. Using the die assembly according to the invention, UHMWPE pellets having improved mechanical properties such as tensile strength, improved density, and reduced oxidation index can be obtained.

### CROSS REFERENCE TO RELATED APPLICATIONS

This application is a National Stage application of PCT/EP2023/058724, filed Apr. 3, 2023, which claims priority to and the benefit of European Patent Application No. 22167458.3, filed on Apr. 8, 2022, the contents of both of which are incorporated by reference herein in their entirety.

### BACKGROUND

The present disclosure relates to a die assembly and process for pelletising ultra-high molecular weight polyethylenes.

Ultra-high molecular weight polyethylenes (UHMWPE) are a particular type of polyethylene materials that exhibit many outstanding properties, such as a high impact strength, a low friction coefficient, and good biocompatibility. These properties make UHMWPE a suitable material for use in applications such as bone joint prostheses, bearings, high-performance fibres, and pipes. UHMWPE typically have a very high molecular weight, long polymer chains, and a high degree of molecular entanglement.

However, the special molecular structure of UHMWPE may result in difficulties in processing the material via melt processing techniques. When the molecular weight of a polyethylene polymer is above 500,000 g/mol, the polymer retains its solid-state behaviour even at temperatures above its melting point, and thus does not exhibit appropriate fluid flow properties that would allow processing of the material via typical melt processing techniques in the field of thermoplastic polymers, such as melt extrusion and injection moulding.

To circumvent this, shaping processes of UHMWPE materials often involve solid powder processing techniques, such as compression moulding and ram extrusion. Each of these techniques however has its disadvantageous aspects. For example, compression moulding is a batch process, and thereby not particularly suitable for high-speed mass production of articles. Next to that, it involves a relatively long processing time, which may result in oxidative degradation of the UHMWPE material during the compression moulding process. And whilst ram extrusion is a quasi-continuous process, further machining of the obtained raw shapes, typically rods, is required, which tends to lead to machine marks on the surfaces of the produced part, which may affect the product aesthetics as well as the mechanical properties, and which leads to generation of waste material that is machined off from the ram extruded rods.

Other constraints to processing UHMWPE materials in common extrusion or injection moulding processes include for example the physical state of the UHMWPE materials that are available for processing. From the polymerisation process, the UHMWPE materials are obtained in a fine powdery form, having very low friction. When one attempts to process such powders via extrusion or injection moulding, the powders tend to rotate along with the rotating screw(s) inside the barrels of the extruder or injection moulding machine, and as a result thereof fail to be conveyed along the screw and move forward towards the die outlet of the extruder or injection moulding machine. Accordingly, it is a challenging task to convert UHMWPE powders into more suitably handling materials, such as for example pellets. Pellets are in this context to be understood to be forms of the material having a size in millimetre (mm) range, such as 2-7 mm in diameter and 3-10 mm in length. Such pellets are often more convenient to process than powdery materials, and thereby desirable to have access to.

Accordingly, a desire exists to have access to more convenient processing methods for UHMWPE materials to produce objects of a desired shape, and in particular to method for producing pellets of UHMWPE.

In the field of polyethylenes, certain variation in nomenclature of the different types of polyethylenes is known to occur in literature. To avoid any unclarity in this regard, a specification of what constitutes UHMWPE is herewith provided. In the context of the present disclosure, an UHMWPE is to be understood as a polymer including recurring polymer units derived from ethylene, preferably consisting of recurring polymer units derived from ethylene, and having a viscosity average molecular weight (Mv) of at least 1,000,000 g/mol. Typical UHMWPE materials may have a viscosity average molecular weight in the range of 1,000,000 to 10,000,000 g/mol, or of 2,000,000 to 8,000,000 g/mol.

For the determination of the viscosity average molecular weight (Mv) of the UHMWPE materials, this is to be calculated in the context of the present disclosure based on the intrinsic viscosity (n) in dl/g, according to the Margolies equation:

$$M v = 5 \text{.37} \cdot {10}^{4} \cdot {η}^{1.49}$$

Mv is the viscosity average molecular weight of the UHMWPE, in g/mol, and n is the intrinsic viscosity of the UHMWPE, in dl/g. The calculation according to the Margolies equation is described in ASTM D4020-11 (Standard Specification for Ultra-High Molecular Weight Polyethylene Molding and Extrusion Materials). The determination of the intrinsic viscosity is to be performed at a temperature of 135° C. in decalin as solvent, according to the method set out in ASTM D2857-95 (Re 2007) (Standard Practice for Dilute Solution Viscosity of Polymers).

### BRIEF SUMMARY

The present disclosure provides for a die assembly that allows for processing of UHMWPE wherein the UHMWPE that is obtained has improved mechanical properties such as tensile strength, improved density, and reduced oxidation index. This is achieved by a die assembly for processing of UHMWPE. The die assembly comprises a circularly enclosed straight channel (1) including an inlet (2) and an outlet (3) construed so that matter may be conveyed through the channel from the inlet towards the outlet along a flow axis (4). The channel comprises a housing (5) to form an enclosure fully enclosing the channel;

The channel comprises a buffer section having a length A and a compression section having a length B, the buffer section positioned at the inlet side of the channel, and the compression section positioned at the outlet side of the channel, the buffer section and the compression section being connected to each other.

The buffer section has a first diameter D1 perpendicular to the flow axis at the side of the inlet of the channel, and a second diameter D2 perpendicular to the flow axis at the side towards the outlet of the channel. D1>D2, preferably to form a tapered channel section at an angle α.

The compression section has a first diameter D3 perpendicular to the flow axis at the side towards the inlet of the channel that corresponds to D2, and a second diameter D4 perpendicular to the flow axis at the side of the outlet of the channel. D3>D4 to form a tapered channel section at an angle β.

Preferably the angle α>β.

Preferably D4 is a circular opening, more preferably each of D1, D2, D3 and D4 are circular.

In the die assembly according to the disclosure, the angle β may preferably be ≥1.0° and ≤10.0°, preferably ≥1.5° and ≤. 5.0°, more preferably ≥1.6°and ≤4.9°, even more preferably ≥1.8° and ≤3.0°.

It is preferred that the outlet diameter of the die assembly D4 is ≥2.0 and ≤8.0 mm, preferably ≥3.0 and ≤6.0 mm.

It is preferred that the channel (1) consists of the buffer section A and the compression section B. Preferably, the die contains no other tapered sections other than the buffer section A and the compression section B.

The length B of the compression section of the channel may for example be ≥20 and ≤100 mm, preferably ≥30 and ≤60 mm.

The ratio of the length B/length A may for example be ≥2.0, preferably ≥4.0.The ratio of D3/D4 may for example be ≥1.2 and ≤2.0, preferably ≥1.3 and ≤1.7.

The die assembly according to the disclosure may be equipped with a cooling unit. Such cooling unit preferably may be configured so that it is capable of cooling the die assembly to a temperature of ≤150° C., more preferably of ≥100° C. and ≤150° C. The cooling unit may for example be a unit providing cooled air to the die assembly, preferably the cooling unit is an air gun.

The die assembly may include multiple channels (1), preferably positioned in parallel.

The disclosure, in certain embodiments, also related to a polymer extruder assembly including a material inlet (6), an extruder barrel (7) including one or two extruder screws (8), and an outlet (9) for removing processed material from the extruder. The outlet comprises the die assembly according to the disclosure.

The extruder may include a cooling unit (10) for cooling the die assembly, preferably for cooling the die assembly to a temperature of ≤150° C., more preferably of ≥100° C. and ≤150° C. The cooling unit may for example be a unit providing cooled air to the die assembly, preferably the cooling unit is an air gun.

The disclosure also relates to a process for production of ultra-high molecular weight polyethylene pellets, the process involving:
i. supplying to a polymer extruder assembly according to the disclosure a polymer composition including an ultra-high molecular weight polyethylene (UHMWPE)
ii. conveying the polymer composition through the polymer extruder;
iii. conveying the polymer composition though the die assembly; and
iv. shaping the polymer composition that exited the polymer extruder via the outlet of the die assembly into pellets by either
a) cooling the polymer composition to a temperature of below the melting temperature, preferably below 100° C., and subsequently cutting the obtained cooled strands into pellets; or
b) cutting the polymer composition into pellets and subsequently cooling the pellets to below the melting temperature, preferably to below 100° C.

It is preferred that the extruder barrel temperature in step ii) is ≥170° C. and ≤220° C. The extruder speed may for example be ≥50 and ≤150 rpm.

It is preferred that the pressure at the inlet of the die assembly is ≥3.0 and ≤8.0 MPa.

The polymer composition preferably comprises ≥90.0 wt % of the UHMWPE, and optionally ≤10.0 wt % of a high-density polyethylene (HDPE), with regard to the total weight of the polymer composition. In a certain embodiment, the polymer composition comprises ≥90.0 wt % of the UHMWPE, and ≤10.0 wt % of a high-density polyethylene (HDPE). For example, the polymer composition may include ≥90.0 wt % and ≤99.0 wt % of the UHMWPE, and ≥1.0 and ≤10.0 wt % of the HDPE, more preferably ≥92.5 wt % and ≤97.5 wt % of the UHMWPE, and ≥2.5 and ≤7.5 wt % of the HDPE.

The UHMWPE may for example have a viscosity average molecular weight (Mv) of ≥2,000,000 g/mol, preferably of ≥2,000,000 and ≤8,000,000 g/mol, more preferably of ≥3,000,000 and ≤8,000,000 g/mol, even more preferably of ≥4,000,000 and ≤8,000,000 g/mol, yet even more preferably of ≥5,000,000 and ≤8,000,000 g/mol. The Mv is calculated via the Margolies equation based on the intrinsic viscosity. The intrinsic viscosity is determined at a temperature of 135° C. in decalin as solvent, according to the method set out in ASTM D2857-95 (Re 2007).

The UHMWPE may for example have a density of >900 kg/m³,preferably of ≥900 kg/m³ and ≤945 kg/m³, more preferably of ≥910 kg/m³ and ≤945 kg/m³, even more preferably of ≥910 kg/m3 and ≤935 kg/m3, yet even more preferably of ≥915 kg/m3 and ≤930 kg/m³.

The HDPE may for example have a molecular weight of ≥50,000 and ≤500,000 g/mol, preferably of ≥50,000 and ≤300,000 g/mol, more preferably of ≥75,000 and ≤250,000 g/mol.

The HDPE may be a homopolymer of ethylene, or a copolymer of ethylene and a comonomer. The comonomer may for example be one selected from 1-butene, 1-hexene or 1-octene. Such HDPE copolymer may for example include ≥0.1 and ≤5.0 wt % of polymeric units derived from the comonomer, with regard to the total weight of the HDPE copolymer, preferably ≥0.1 and ≤3.0 wt %, more preferably ≥0.3 and ≤3.0 wt %.

The HDPE may for example have a density of ≥946 and ≤975 kg/m³, preferably of ≥950 and ≤970 kg/m³, more preferably of ≥950 and ≤965 kg/m³, as determined in accordance with ASTM D792 (2008).

The HDPE may for example have a melt mass-flow rate of ≥0.1 and ≤100 g/10 min, as determined at 190°C. at 2.16 kg load in accordance with ASTM D1238 (2013), preferably of ≥0.5 and ≤50 g/10 min, more preferably of ≥1.0 and ≤25 g/10 min, even more preferably of ≥3.0 and ≤15.0 g/10 min, yet even more preferably of ≥5.0 and ≤10.0 g/10 min.

### BRIEF DESCRIPTION OF THE DRAWINGS

A brief description of the drawings is provided herewith, in which:

FIG. 1 presents a die assembly of a certain embodiment of the disclosure, including a tapered compression zone;

FIG. 2 presents an alternative configuration of the die assembly, showing an alternative geometry of the buffer zone;

FIG. 3 shows a polymer extruder assembly including a die assembly according to the disclosure;

FIG. 4 shows a conventional die assembly, not including the compression zone as defined according to the present disclosure; and

FIG. 5 shows the content extruded from the barrel of the extruder by removal of the die from the extruder, thereby reflecting the processing status of the content of the extruder during processing of the UHMWPE material.

### DETAILED DESCRIPTION

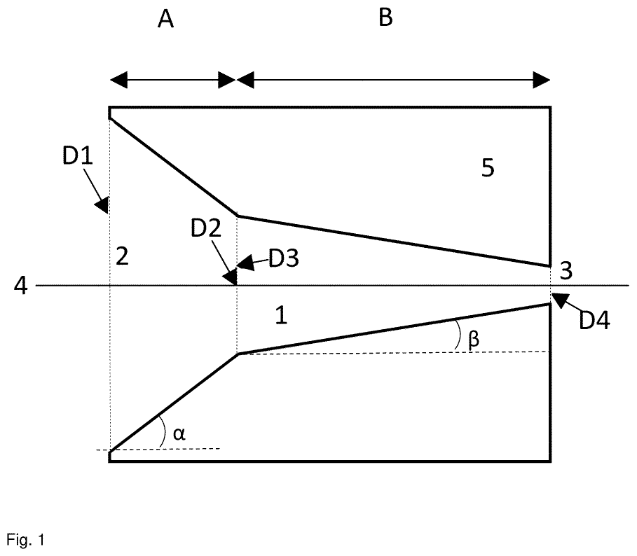

Turning to FIG. 1, the figure presents a die assembly of a certain embodiment of the disclosure, including a tapered compression zone. In FIG. 1, the die assembly comprises a housing (5), including a channel (1), having an inlet (2) and an outlet (3). Material can flow along this channel in the direction of the flow axis (4). The assembly comprises a buffer zone having length A, and a compression zone having length B. D1 indicates the diameter of the entry of the buffer zone, and D2 the diameter of the outlet of the buffer zone; D3 indicates the diameter of the inlet of the compression zone, and D4 the diameter of the outlet of the compression zone.

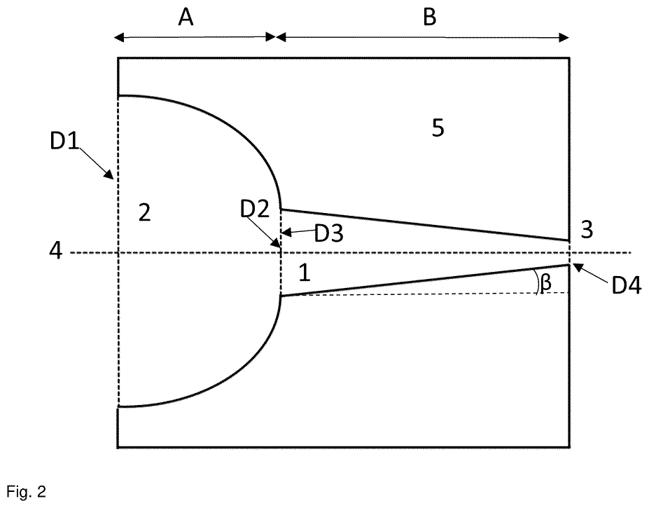

Turning to FIG. 2, the figure presents an alternative configuration of the die assembly, showing an alternative geometry of the buffer zone. The indicators 1-5, A-B and D1-D4 of FIG. 2 correspond to those of FIG. 1 as explained above.

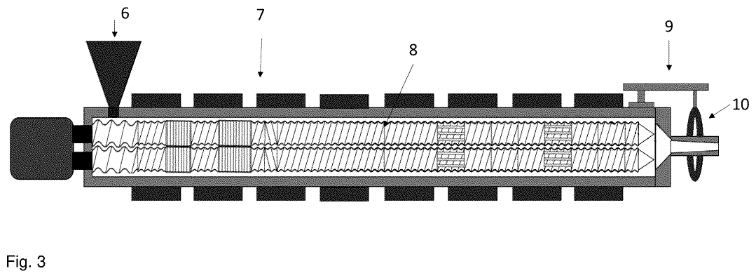

Turning to FIG. 3, the figure shows a polymer extruder assembly including a die assembly according to the disclosure. The extruder comprises a material inlet (6), an extruder barrel (7) including one or two extruder screws, and an outlet (9) for removing processed material from the extruder. The outlet comprises the die assembly according to the disclosure. The extruder assembly of FIG. 3 further shows a cooling unit (10) for cooling the die assembly.

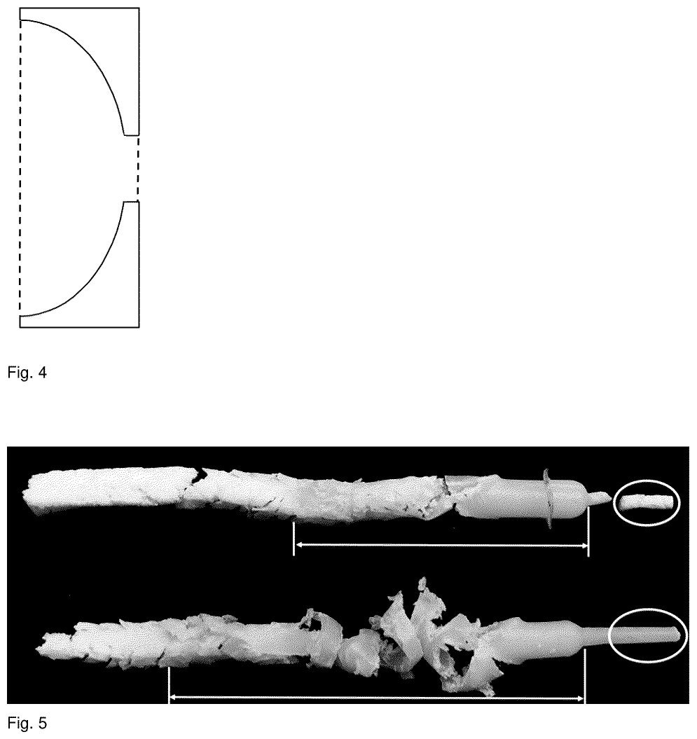

Turning to FIG. 4, the figure shows a conventional die assembly, not including the compression zone as defined according to the present disclosure.

Turning to FIG. 5, the figure shows the content extruded from the barrel of the extruder by removal of the die from the extruder, thereby reflecting the processing status of the content of the extruder during processing of the UHMWPE material. The top image in FIG. 5 shows the material as obtained from an extraction of the extruder content in the situation that the extruder was equipped with the conventional die assembly according to FIG. 4; the bottom image in FIG. 5 shows the material obtained in the situation that the extruder was equipped with the die assembly according to the present disclosure, using the configuration of FIG. 1.

More specifically, the present disclosure provides for a die assembly that allows for processing of UHMWPE wherein the UHMWPE that is obtained has improved mechanical properties such as tensile strength, improved density, and reduced oxidation index. As shown in the figures, this is achieved by a die assembly for processing of UHMWPE. The die assembly comprises a circularly enclosed straight channel (1) including an inlet (2) and an outlet (3) construed so that matter may be conveyed through the channel from the inlet towards the outlet along a flow axis (4). The channel comprises a housing (5) to form an enclosure fully enclosing the channel.

The channel comprises a buffer section having a length A and a compression section having a length B, the buffer section positioned at the inlet side of the channel, and the compression section positioned at the outlet side of the channel, the buffer section and the compression section being connected to each other.

The buffer section has a first diameter D1 perpendicular to the flow axis at the side of the inlet of the channel, and a second diameter D2 perpendicular to the flow axis at the side towards the outlet of the channel. D1>D2, preferably to form a tapered channel section at an angle α.

The compression section has a first diameter D3 perpendicular to the flow axis at the side towards the inlet of the channel that corresponds to D2, and a second diameter D4 perpendicular to the flow axis at the side of the outlet of the channel. D3>D4 to form a tapered channel section at an angle β.

Preferably the angle α>β.

Preferably D4 is a circular opening, more preferably each of D1, D2, D3 and D4 are circular.

In the die assembly according to the disclosure, the angle β may preferably be ≥1.0° and ≤ 10.0°, preferably ≥1.5° and ≤. 5.0°, more preferably ≥ 1.6° and ≤ 4.9°, even more preferably ≥ 1.8° and ≤3.0°.

It is preferred that the outlet diameter of the die assembly D4 is ≥2.0 and ≤8.0 mm, preferably ≥3.0 and ≤6.0 mm.

It is preferred that the channel (1) consists of the buffer section A and the compression section B. Preferably, the die contains no other tapered sections other than the buffer section A and the compression section B.

The length B of the compression section of the channel may for example be ≥20 and ≤100 mm, preferably ≥30 and ≤60 mm.

The ratio of the length B/length A may for example be ≥2.0, preferably ≥4.0.

The ratio of D3/D4 may for example be ≥1.2 and ≤2.0, preferably ≥1.3 and ≤1.7.

The die assembly according to the disclosure may be equipped with a cooling unit. Such cooling unit preferably may be configured so that it is capable of cooling the die assembly to a temperature of ≤150° C., more preferably of ≥100° C. and ≤150° C. The cooling unit may for example be a unit providing cooled air to the die assembly, preferably the cooling unit is an air gun.

The die assembly may include multiple channels (1), preferably positioned in parallel.

The disclosure, in certain embodiments, also related to a polymer extruder assembly including a material inlet (6), an extruder barrel (7) including one or two extruder screws (8), and an outlet (9) for removing processed material from the extruder. The outlet comprises the die assembly according to the disclosure.

The extruder may include a cooling unit (10) for cooling the die assembly, preferably for cooling the die assembly to a temperature of ≤150° C., more preferably of ≥100° C. and ≤150° C. The cooling unit may for example be a unit providing cooled air to the die assembly, preferably the cooling unit is an air gun.

The disclosure also relates to a process for production of ultra-high molecular weight polyethylene pellets. The process involves:
i. supplying to a polymer extruder assembly according to the disclosure a polymer composition including an ultra-high molecular weight polyethylene (UHMWPE);
ii. conveying the polymer composition through the polymer extruder;
iii. conveying the polymer composition though the die assembly; and
iv. shaping the polymer composition that exited the polymer extruder via the outlet of the die assembly into pellets by either:
a) cooling the polymer composition to a temperature of below the melting temperature, preferably below 100° C., and subsequently cutting the obtained cooled strands into pellets; or
b) cutting the polymer composition into pellets and subsequently cooling the pellets to below the melting temperature, preferably to below 100° C.

It is preferred that the extruder barrel temperature in step ii) is ≥170° C. and ≤220° C. The extruder speed may for example be ≥50 and ≤150 rpm.

It is preferred that the pressure at the inlet of the die assembly is ≥3.0 and ≤8.0 MPa.

The polymer composition preferably comprises ≥90.0 wt % of the UHMWPE, and optionally ≤10.0 wt % of a high-density polyethylene (HDPE), with regard to the total weight of the polymer composition. In a certain embodiment, the polymer composition comprises ≥90.0 wt % of the UHMWPE, and ≤10.0 wt % of a high-density polyethylene (HDPE). For example, the polymer composition may include ≥90.0 wt % and ≤99.0 wt % of the UHMWPE, and ≥1.0 and ≤10.0 wt % of the HDPE, more preferably ≥92.5 wt % and ≤97.5 wt % of the UHMWPE, and ≥2.5 and ≤7.5 wt % of the HDPE.

The UHMWPE may for example have a viscosity average molecular weight (Mv) of ≥2,000,000 g/mol, preferably of ≥2,000,000 and ≤8,000,000 g/mol, more preferably of ≥3,000,000 and ≤8,000,000 g/mol, even more preferably of ≥4,000,000 and ≤8,000,000 g/mol, yet even more preferably of ≥5,000,000 and ≤8,000,000 g/mol. The Mv is calculated via the Margolies equation based on the intrinsic viscosity. The intrinsic viscosity is determined at a temperature of 135° C. in decalin as solvent, according to the method set out in ASTM D2857-95 (Re 2007).

The UHMWPE may for example have a density of ≥900 kg/m³, preferably of ≥900 kg/m³ and ≤945 kg/m³, more preferably of ≥910 kg/m³ and ≤945 kg/m³, even more preferably of ≥910 kg/m³ and ≤935 kg/m³, yet even more preferably of ≥915 kg/m³ and ≤930 kg/m³.

The HDPE may for example have a molecular weight of ≥50,000 and ≤500,000g/mol, preferably of ≥50,000 and ≤300,000 g/mol, more preferably of ≥75,000 and ≤250,000 g/mol.

The HDPE may be a homopolymer of ethylene, or a copolymer of ethylene and a comonomer. The comonomer may for example be one selected from 1-butene, 1-hexene or 1-octene. Such HDPE copolymer may for example include ≥0.1 and ≤5.0 wt % of polymeric units derived from the comonomer, with regard to the total weight of the HDPE copolymer, preferably ≥0.1 and ≤3.0 wt %, more preferably ≥0.3 and ≤3.0 wt %.

The HDPE may for example have a density of ≥946 and ≤975 kg/m³, preferably of ≥950 and ≤970 kg/m³, more preferably of ≥950 and ≤ 965 kg/m³, as determined in accordance with ASTM D792 (2008).

The HDPE may for example have a melt mass-flow rate of ≥0.1 and ≤100 g/10min, as determined at 190° C. at 2.16 kg load in accordance with ASTM D1238 (2013), preferably of ≥0.5 and ≤50 g/10 min, more preferably of ≥1.0 and ≤25 g/10 min, even more preferably of ≥3.0 and ≤15.0 g/10 min, yet even more preferably of ≥5.0 and ≤10.0 g/10 min.

The embodiments of the disclosure will now be illustrated by the following non-limiting examples.

A Leistritz ZSE-18 co-rotating twin-screw extruder was used in the examples of the present disclosure. The extruder was suitable to be fitted with either a conventional die according to the design of FIG. 4, including a buffer zone directly connected to a circular outlet opening with a diameter of 4.5 mm, or a tapered die according to the present disclosure, as shown in FIG. 1. The tapered die had a compression zone length of 35 mm, a tapered angle of the compression zone of 2°, and a diameter of the outlet opening of 4.5 mm. The extruder was operated at a temperature profile with each zone heated to 180° C., except for the die zone, which was heated to 170° C. The extruder was operated at a speed of 80 rpm. The feed rate of the polymer composition to the extruder was 0.53 kg/h. The extruder was equipped with an air gun to provide cooled air to the tapered die.

Experiments were conducted wherein either the conventional die or with the tapered die, and both with and without air cooling applied.

As materials, a UHMWPE having an Mv of 5,000,000 g/mol and a density of 920 kg/m³ was used. Formulations were made of either 99.5 wt % of this UHMWPE with 0.5 wt % of antioxidant (Irganox 1010), or blends of 94.5 wt % UHMWPE, 0.5 wt % of the antioxidant, and 5.0 wt % of SABIC CC860V, an HDPE having a density of 960 kg/m³, a melt mass-flow rate (190° C., 2.16 kg) of 7.6 g/10 min, and an Mv of 78,000 g/mol.

During extrusion, the pressure at the inlet of the die assembly, also referred to as the back pressure, was determined. The results thereof are presented in Table 1 below.

TABLE 1

| | | | | Back |
|---|---|---|---|---|
| | | | Air | pressure |
| Example | Formulation | Die | Cooling | (MPa) |
| 1 | 99.5% UHMWPE, | Conventional | No | 2.8 |
| | 0.5% antioxidant | | | |
| 2 | 99.5% UHMWPE, | Tapered | No | 3.2 |
| | 0.5% antioxidant | | | |
| 3 | 99.5% UHMWPE, | Tapered | Yes | 6.6 |
| | 0.5% antioxidant | | | |
| 4 | 94.5% UHMWPE, | Conventional | No | 2.4 |
| | 0.5% antioxidant, | | | |
| | 5.0% HDPE | | | |
| 5 | 94.5% UHMWPE, | Tapered | No | 3.0 |
| | 0.5% antioxidant, | | | |
| | 5.0% HDPE | | | |
| 6 | 94.5% UHMWPE, | Tapered | Yes | 4.9 |
| | 0.5% antioxidant, | | | |
| | 5.0% HDPE | | | |

The products that were obtained were cut into pellets for further processing. Samples of the product obtained in each example were subsequently processed into test samples via compression moulding using a CARVER press (1NE100). Pellets were placed between two steel plates. The compression moulding took place at 200° C., under a 10 MPa pressure, for 2 min to produce film samples, and for 20 min to produce ASTM type V tensile test samples.

Of the pellets obtained, density was determined using a magnetic levitation (MagLev) method. The magnetic levitation device contains two magnets with the same poles facing each other. The samples and magnets were immersed in a paramagnetic medium of 1 mol/L MnCl₂ solution. The densities of samples then were calculated after obtaining the samples' respective levitation heights. The larger the density of the sample, the lower the height obtained due to the magnetic field in the magnetic medium. The obtained results are shown in Table 2 below.

TABLE 2

| Example | 1 | 2 | 3 | 4 | 5 | 6 |
|---|---|---|---|---|---|---|
| Density | 0.908 | 0.917 | 0.925 | 0.910 | 0.918 | 0.935 |
| (g/cm³) | | | | | | |

The density of the pellets produced with the tapered die was higher than of those produced with the conventional die, and density increased further still when air cooling was applied. The density measurements support the visual observation of the extrudate as show in FIG. 5, where it can be observed that the extrudate (encircled on the right side in the FIG. 5) in the experiment using the tapered die (bottom image in FIG. 5) showed better consolidated matter than in the experiment using the conventional die (top image in FIG. 5). Also, FIG. 5 revealed that the length of the melt section in the extruder was longer in the experiment using the tapered die than in the experiment using the conventional die (melt section indicated as the part marked by the arrows in FIG. 5). Use of the air cooling further increased the density of the pellets. The increase in density using the combination of the tapered die and the air cooling in the experiment that produced example 6 wherein the blend of UHMWPE and HDPE is used appears to suggest that HDPE may act as a binder and that the process may help fill fusion defects between UHMWPE and HDPE phases.

Tensile tests were performed on compression moulded samples as per the method described above. Tensile testing was performed according to the method of ASTM D638-14. The tensile strength results that were obtained are presented in Table 3 below.

TABLE 3

| Example | 1 | 2 | 4 | 5 |
|---|---|---|---|---|
| Tensile strength (MPa) | 38.3 | 40.6 | 46.5 | 50.1 |

It can be observed that tests performed on samples obtained using the die of the present disclosure showed an increase in the tensile strength, both in the case of using UHMWPE (example 2 vs. 1) as in the case of using a blend of UHMWPE with HDPE (example 5 vs. 4).

To determine the oxidation index, measurements according to ISO 5834-4 (2019) were performed. The oxidation index (I_{OX}) was calculated as:

$${I}_{OX} = \frac{{A}_{Ox}}{{A}_{N o r m}}$$

A_{Ox} is the integrated area in the Fourier transform infrared (FTIR) spectrum in the range of 1650 cm-1 to 1850 cm-1, representing the oxidation peak area, and A_{Norm} is the integrated area in the FTIR spectrum in the range of 1330 cm⁻¹ to 1396 cm⁻¹, representing the normalisation peak area. A higher lox indicates a higher oxidation level. The results for lox as obtained are presented in Table 4 below.

TABLE 4

| Example | 1 | 2 | 4 | 5 |
|---|---|---|---|---|
| I_{OX} | 0.17 | 0.15 | 0.22 | 0.19 |

The results in Table 4 indicate that a reduced oxidation index is obtained when using the die assembly according to the disclosure (examples 2 and 5, compared with 1 and 4 respectively).

1. A die assembly for processing of UHMWPE, the die assembly comprising:
a circularly enclosed straight channel having an inlet and an outlet, construed to convey matter through the channel from the inlet towards the outlet along a flow axis,
wherein the channel comprises a housing to form an enclosure fully enclosing the channel,
wherein the channel comprises:
a buffer section having a length A; and
a compression section having a length B,
wherein:
the buffer section is positioned at an inlet side of the channel;
the compression section is positioned at an outlet side of the channel; and
the buffer section and the compression section are connected to each other,
wherein the buffer section has:
a first diameter D1 perpendicular to the flow axis at the side of the inlet of the channel; and
a second diameter D2 perpendicular to the flow axis at the side towards the outlet of the channel,
wherein D1>D2; and
wherein the compression section has:
a first diameter D3 perpendicular to the flow axis at the side towards the inlet of the channel that corresponds to D2; and
a second diameter D4 perpendicular to the flow axis at the side of the outlet of the channel, wherein D3>D4 to form a tapered channel section at an angle β.

2. The die assembly of claim 1, wherein the angle β is ≥1.0° and ≤10.0°.

3. The die assembly of claim 1, wherein the channel consists of the buffer section A and the compression section B.

4. The die assembly of claim 1, wherein the length B of the compression section of the channel is ≥20 and ≤100 mm.

5. The die assembly of claim 1, wherein a ratio of the length B/length A is ≥2.0.

6. The die assembly of claim 1, wherein the a ratio of D3/D4 is ≥1.2 and ≤2.0.

7. A polymer extruder assembly comprising:
a material inlet;
an extruder barrel comprising one or two extruder screws; and
an outlet for removing processed material from the extruder,
wherein the outlet comprises the die assembly of claim 1.

8. The polymer extruder of claim 7, wherein the extruder comprises a cooling unit for cooling the die assembly.

9. The polymer extruder of claim 8, wherein the cooling unit is a unit providing cooled air to the die assembly.

10. A process for production of ultra-high molecular weight polyethylene pellets, the process comprising:
i. supplying, to the polymer extruder assembly of claim 7, a polymer composition comprising an ultra-high molecular weight polyethylene (UHMWPE);
ii. conveying the polymer composition through the polymer extruder;
iii. conveying the polymer composition though the die assembly; and
iv. shaping the polymer composition that exited the polymer extruder via the outlet of the die assembly into pellets by either:
a) cooling the polymer composition to a temperature of below the melting temperature, and subsequently cutting the obtained cooled strands into pellets; or
b) cutting the polymer composition into pellets and subsequently cooling the pellets to below the melting temperature.

11. The process of claim 10, wherein the extruder barrel temperature in step ii) is ≥170° C. and ≤220° C.

12. The process of claim 10, wherein the extruder speed is ≥50 and ≤150 rpm.

13. Process of claim 10, wherein the pressure at the inlet of the die assembly is ≥3.0 and ≤8.0 MPa.

14. The process of claim 10, wherein the polymer composition comprises ≥90.0 wt % of the UHMWPE, with regard to the total weight of the polymer composition.

15. The process of claim 10, wherein:
the UHMWPE has a viscosity average molecular weight (Mv) of ≥2,000,000 g/mol;
the viscosity average molecular weight is calculated via the Margolies equation based on the intrinsic viscosity; and
the intrinsic viscosity is determined at a temperature of 135° C. in decalin as solvent, according to the method set out in ASTM D2857-95 (Re 2007).

16. The assembly of claim 1, wherein the buffer section forms a tapered channel section at an angle α.

17. The assembly of claim 16, wherein the angle α>β.

18. The assembly of claim 1, wherein at least one of D1, D2, D3 and D4 is circular.

19. The process of claim 14, wherein the polymer composition comprises ≤10.0 wt % of a high-density polyethylene (HDPE), with regard to the total weight of the polymer composition.

20. A process for production of ultra-high molecular weight polyethylene pellets, the process comprising:
i. supplying, to a polymer extruder, a polymer composition comprising an ultra-high molecular weight polyethylene (UHMWPE);
ii. conveying the polymer composition through the polymer extruder;
iii. conveying the polymer composition though a die assembly of the polymer extruder; and
iv. shaping the polymer composition that exited the polymer extruder via the outlet of the die assembly into pellets by either:
c) cooling the polymer composition to a temperature of below the melting temperature, and subsequently cutting the obtained cooled strands into pellets; or
d) cutting the polymer composition into pellets and subsequently cooling the pellets to below the melting temperature;
wherein the extruder barrel temperature in step ii) is ≥170° C. and ≤220° C.;
wherein the extruder speed is ≥50 and ≤150 rpm;
wherein the pressure at the inlet of the die assembly is ≥3.0 and ≤8.0 MPa;
wherein the polymer composition comprises ≥90.0 wt % of the UHMWPE, with regard to the total weight of the polymer composition; and
wherein:
the UHMWPE has a viscosity average molecular weight (Mv) of ≥2,000,000 g/mol;
the viscosity average molecular weight is calculated via the Margolies equation based on the intrinsic viscosity; and
the intrinsic viscosity is determined at a temperature of 135° C. in decalin as solvent, according to the method set out in ASTM D2857-95 (Re 2007).
